(19) United States
(12) Patent Application Publication
(10) Pub. No.: US 2023/0256979 A1
(43) Pub. Date: Aug. 17, 2023

(54) AUTOMATED VIBRATION BASED COMPONENT WEAR AND FAILURE DETECTION FOR VEHICLES

(71) Applicant: Robert Bosch GmbH, Stuttgart (DE)

(72) Inventors: Richard T. Nesbitt, Dexter, MI (US); Ole Wendroth, Ann Arbor, MI (US)

(21) Appl. No.: 17/985,668

(22) Filed: Nov. 11, 2022

Related U.S. Application Data
(60) Provisional application No. 63/309,139, filed on Feb. 11, 2022.

(51) Int. Cl. B60W 50/02; B60W 60/00

(52) U.S. Cl. CPC B60W 50/0205; B60W 50/0225; B60W 60/00186; B60W 2556/10

(57) ABSTRACT

Systems and methods for detecting component anomalies for a vehicle using sensed vibrations. One example system includes a first sensor positioned at a first position on the vehicle and configured to sense vibrations of the vehicle and an electronic processor communicatively coupled to the first sensor. The electronic processor is configured to receive, from the first sensor, sensor information produced by a sensed vibration of the vehicle. The electronic processor is configured to determine, based on the sensor information, a vibration pattern. The electronic processor is configured to determine, based on the vibration pattern, whether a component anomaly exists. The electronic processor is configured to, in response to determining that a component anomaly exists, execute a mitigation action based on the component anomaly.

### CROSS-REFERENCE TO RELATED APPLICATION

The present application is related to and claims benefit under 35 U.S.C. § 119(e) from U.S. Provisional Patent Application Serial No. 63/309,139, filed Feb. 11, 2022, entitled “Vibration Based Component Wear and Failure Detection for Vehicles,” the entire contents of which being incorporated herein by reference.

### BACKGROUND OF THE INVENTION

A driver of a vehicle can detect component abnormalities or failures for various vehicle subsystems including the transmission, suspension, wheel balancing, wheel alignment, brake rotors, wheel bearings, tie rods, exhaust, engine, and the like. The driver observes these abnormalities and failures based on noise, vibration, or harshness (NVH) feedback inside of the cabin. Some vehicles capable of autonomous driving may be used to provide taxicab services or may be used for ride sharing applications. In both cases, there may not be a regular occupant or operator of the vehicle. In some instances, fully autonomous taxicabs ferry passengers without the presence of a human driver in the vehicle. While operating, such vehicles may experience component wear or failure.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a block diagram of a vehicle control system, in accordance with some examples.

FIG. 2 schematically illustrates an electronic controller of the system of FIG. 1, in accordance with some examples.

FIG. 3 is a flow chart of an example method for detecting component wear and failure, in accordance with some examples.

FIG. 4 is a block diagram of a vehicle control system, in accordance with some examples.

FIG. 5 is a flow chart of an example method for detecting component wear and failure, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As vehicles operate on the roadways, they may experience component failure caused by ordinary wear, damage, or other circumstances. As noted, fully autonomous taxicabs may operate to ferry passengers without the presence of a human driver in the vehicle. In addition, fully or partially autonomous vehicles may operate as part of a fleet or a ride-sharing program. As a consequence, an occupant or driver may not engage regularly enough with the same vehicle to detect component abnormalities or failures. Vehicles are equipped with sensors to detect vehicle conditions.

Although minor wear may not affect the technical functionality of the vehicle, it may still be desirable to attend to minor wear before it causes larger problems. Additionally, some noise, vibration, or harshness feedback may indicate a more serious or impending problem, which may render the vehicle inoperable. Without a human driver present or willing to determine and act on the cause of such feedback, there is a need for the autonomous vehicle to be capable of doing so automatically. Accordingly, systems and methods are provided herein for, among other things, automated component wear and failure detection, classification, and mitigation for vehicle systems, including autonomous driving systems.

Examples described herein provide systems that use vibration patterns (for example, sensed using an accelerometer or another type of vibration sensor) and other sensor inputs to detect component wear and failure. Using such examples, mitigations measures can be taken, if necessary, based on the anomaly detected. For example, the vehicle can notify its operator (for example, a fleet operator), contact the appropriate authorities, or both, depending on the nature of the component anomaly. Similarly, the vehicle can pull off the road, travel to an operations center for further investigation, or take other appropriate measures based on the component anomaly.

One example embodiment provides a system for detecting component anomalies for a vehicle. The system includes a first sensor positioned at a first position on the vehicle and configured to sense vibrations of the vehicle and an electronic processor communicatively coupled to the first sensor. The electronic processor is configured to receive, from the first sensor, sensor information produced by a sensed vibration of the vehicle. The electronic processor is configured to determine, based on the sensor information, a vibration pattern. The electronic processor is configured to determine, based on the vibration pattern, whether a component anomaly exists. The electronic processor is configured to, in response to determining that a component anomaly exists, execute a mitigation action based on the component anomaly.

Another example embodiment provides a method for detecting component anomalies for a vehicle. The method includes receiving, from a first sensor positioned at a first position on the vehicle, sensor information produced by a sensed vibration of the vehicle. The method includes comparing, with an electronic processor communicatively coupled to the first sensor, the sensor information to a vibration noise floor to extract one or more vibrations that exceed the vibration noise floor. The method includes generating a vibration pattern based on the one or more vibrations that exceed the vibration noise floor. The method includes determining, based on the vibration pattern, whether a component anomaly exists. The method includes, in response to determining that a component anomaly exists, executing a mitigation action based on the component anomaly.

As used herein, the term “component anomaly” refers to either component failure or a condition of a vehicle component, system, or subsystem, which is out of the acceptable range for the component, system, or subsystem. Examples of component anomalies include transmission anomalies (for example, an aging universal joint, a low fluid level, or a failing torque converter), suspension anomalies (for example, worn shocks, ball joints, sway bar mounts, and control arm bushings), unbalanced wheels, improper wheel alignment, warped brake rotors, failing wheel bearings, failing tie rods, exhaust system anomalies (for example, leaks or a failing muffler), and engine anomalies (for example, an improperly mounted or worn drive belt or worn motor mounts).

Before any aspects of the invention are explained in detail, it is to be understood that the invention is not limited in its application to the details of construction and the arrangement of components set forth in the following description or illustrated in the following drawings. The invention is capable of being practiced or of being carried out in various ways.

It should also be noted that a plurality of hardware and software-based devices, as well as a plurality of different structural components may be used to implement the invention. In addition, it should be understood that examples presented herein may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (for example, stored on non-transitory computer-readable medium) executable by one or more processors. As such, it should be noted that a plurality of hardware and software-based devices, as well as a plurality of different structural components may be utilized to implement the invention. For example, “control units” and “controllers” described in the specification can include one or more electronic processors, one or more physical memory modules including non-transitory computer-readable medium, one or more input/output interfaces, and various connections (for example, a system bus) connecting the components.

For ease of description, some or all of the example systems presented herein are illustrated with a single exemplar of each of its component parts. Some examples may not describe or illustrate all components of the systems. Other examples may include more or fewer of each of the illustrated components, may combine some components, or may include additional or alternative components.

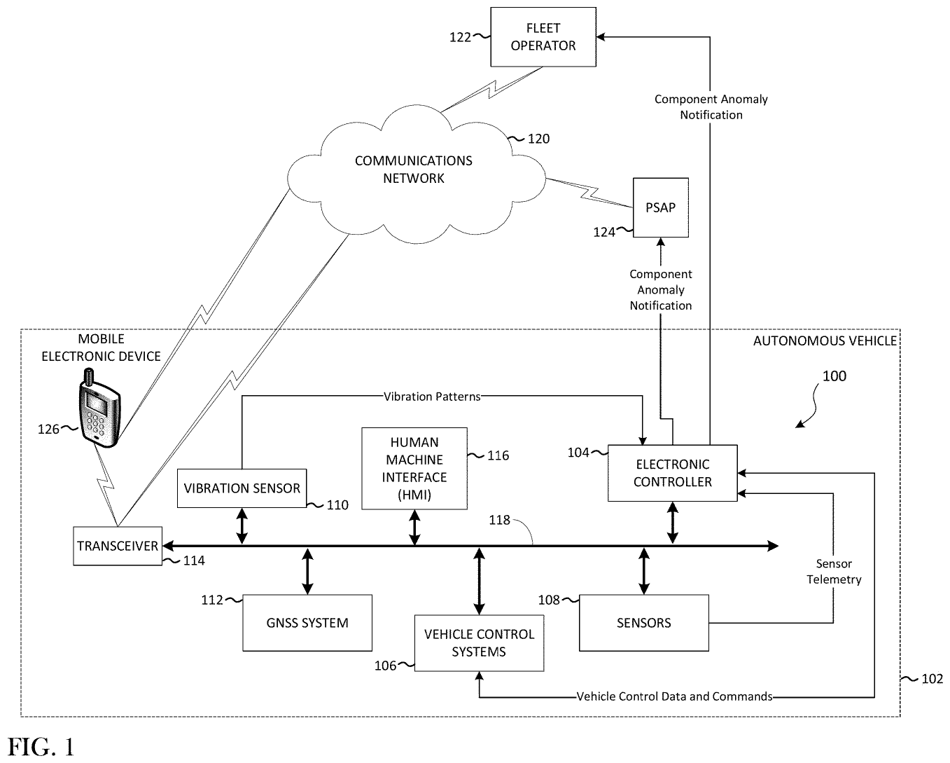

FIG. 1 is a block diagram of one example of an autonomous vehicle control system 100. As described more particularly below, the autonomous vehicle control system 100 may be mounted on, or integrated into, a vehicle 102 and autonomously drives the vehicle. It should be noted that, in the description that follows, the terms “autonomous vehicle” and “automated vehicle” should not be considered limiting. The terms are used in a general way to refer to an autonomous or automated driving vehicle, which possesses varying degrees of automation (that is, the vehicle is configured to drive itself with limited, or in some cases no, input from a driver). The systems and methods described herein may be used with any vehicle capable of operating partially or fully autonomously, being controlled manually by a driver, or some combination of both. The term “driver,” as used herein, generally refers to an occupant of an autonomous vehicle who is seated in the driver's position, operates the controls of the vehicle while in a manual mode, or provides control input to the vehicle to influence the autonomous operation of the vehicle.

In the example illustrated, the system 100 includes an electronic controller 104, vehicle control systems 106, sensors 108, a vibration sensor 110, a GNSS (global navigation satellite system) system 112, a transceiver 114, and a human machine interface (HMI) 116. The components of the system 100, along with other various modules and components are electrically coupled to each other by or through one or more control or data buses (for example, the bus 118), which enable communication therebetween. The use of control and data buses for the interconnection between, and communication among, the various modules and components would be known to a person skilled in the art in view of the invention described herein. In some instances, the bus 118 is a Controller Area Network (CAN™) bus. In some instances, the bus 118 is an automotive Ethernet™, a FlexRay™ communications bus, or another suitable wired bus. In alternative embodiments, some or all of the components of the system 100 may be communicatively coupled using suitable wireless modalities (for example, Bluetooth™ or near field communication). For ease of description, the system 100 illustrated in FIG. 1 includes one of each of the foregoing components. Alternative embodiments may include one or more of each component or may exclude or combine some components.

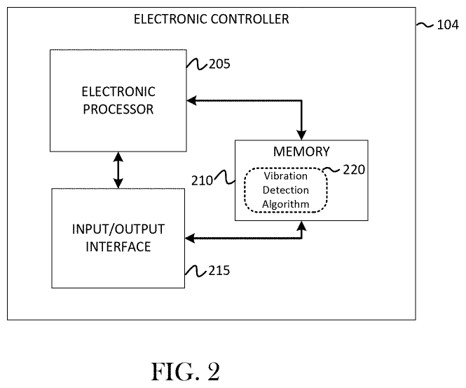

The electronic controller 104 (described more particularly below with respect to FIG. 2) operates the vehicle control systems 106 and the sensors 108 to fully or partially autonomously control the vehicle as described herein. The electronic controller 104 receives sensor telemetry from the sensors 108 and determines control data and commands for the vehicle. The electronic controller 104 transmits the vehicle control data to, among other things, the vehicle control systems 106 to drive the vehicle (for example, by generating braking signals, acceleration signals, steering signals).

The vehicle control systems 106 include controllers, sensors, actuators, and the like for controlling aspects of the operation of the vehicle 102 (for example, steering, acceleration, braking, shifting gears, and the like). The vehicle control systems 106 are configured to send and receive data relating to the operation of the vehicle 102 to and from the electronic controller 104.

The sensors 108 determine one or more attributes of the vehicle and its surrounding environment and communicate information regarding those attributes to the other components of the system 100 using, for example, electrical signals. The vehicle attributes include, for example, the position of the vehicle or portions or components of the vehicle, the movement of the vehicle or portions or components of the vehicle, the forces acting on the vehicle or portions or components of the vehicle, the proximity of the vehicle to other vehicles or objects (stationary or moving), yaw rate, sideslip angle, steering wheel angle, superposition angle, vehicle speed, longitudinal acceleration, and lateral acceleration, and the like. The sensors 108 may include, for example, vehicle control sensors (for example, sensors that detect accelerator pedal position, brake pedal position, and steering wheel position [steering angle]), wheel speed sensors, vehicle speed sensors, yaw sensors, force sensors, odometry sensors, and vehicle proximity sensors (for example, camera, radar, LIDAR, and ultrasonic). In some instances, the sensors 108 include one or more cameras configured to capture one or more images of the environment surrounding the vehicle 102 according to their respective fields of view. The cameras may include multiple types of imaging devices/sensors, each of which may be located at different positions on the interior or exterior of the vehicle 102.

The vibration sensor 110 is a transducer capable of sensing vibrations in a vehicle component, converting the vibrations to electrical signals, and transmitting the electrical signals to the electronic controller 104. In some instances, the vibration sensor 110 is an accelerometer. In some instances, the vibration sensor may be a strain gauge, an eddy-current sensor, a gyroscope, a microphone, or another suitable vibration sensor. In some instances, the vibration sensor 110 may be integrated into another vehicle sensor (for example, combined with a wheel speed sensor of the vehicle 102). In some instances, multiple vibration sensors are used, for example, mounted on each of the vehicle's wheels, or at different points on the vehicle's chassis. In some instances, the vibration sensor 110 is implemented using micro-electrical-mechanical system (MEMS) technology. As described herein, the electronic controller 104 processes the electrical signals received from the vibration sensor 110 to produce a vibration pattern, which may be analyzed to determine a component anomaly, which is causing the vibration. In some instances, the vibration sensor 110 includes on board signal processing circuitry, which produces and transmits sensor information including vibration patterns to the electronic controller 104 for processing.

The electronic controller 104 receives and interpret the signals received from the sensors 108 and the vibration sensor 110 to automatically detect wear and failure in some of the vehicle's components.

In some instances, the system 100 includes, in addition to the sensors 108, a GNSS (global navigation satellite system) system 112. The GNSS system 112 receives radiofrequency signals from orbiting satellites using one or more antennas and receivers (not shown). The GNSS system 112 determines geo-spatial positioning (i.e., latitude, longitude, altitude, and speed) for the vehicle based on the received radiofrequency signals. The GNSS system 112 communicates this positioning information to the electronic controller 104. The electronic controller 104 may use this information in conjunction with or in place of information received from some of the sensors 108 when controlling the autonomous vehicle 102.

The transceiver 114 includes a radio transceiver communicating data over one or more wireless communications networks (for example, cellular networks, satellite networks, land mobile radio networks, etc.) including the communications network 120. The communications network 120 is a communications network including wireless connections, wired connections, or combinations of both. The communications network 120 may be implemented using a wide area network, for example, the Internet (including public and private IP networks), a Long Term Evolution (LTE) network, a Global System for Mobile Communications (or Groupe Spécial Mobile (GSM)) network, a Code Division Multiple Access (CDMA) network, an Evolution-Data Optimized (EV-DO) network, an Enhanced Data Rates for Global Evolution (EDGE) network, a 3G network, a 4G network, 5G network and one or more local area networks, for example, a Bluetooth™ network or Wi-Fi network, and combinations or derivatives thereof.

The transceiver 114 also provides wireless communications within the vehicle using suitable network modalities (for example, Bluetooth™, near field communication (NFC), Wi-Fi™, and the like). Accordingly, the transceiver 114 communicatively couples the electronic controller 104 and other components of the system 100 with networks or electronic devices both inside and outside the vehicle 102. For example, the electronic controller 104, using the transceiver 114, can communicate with a fleet operator 122 for the autonomous vehicle 102 to send and receive data, commands, and other information (for example, component anomaly notifications). In another example, the electronic controller 104, using the transceiver 114, can contact emergency authorities (for example, the public safety answering point (PSAP) 124) using enhanced 911 (E911) communications modalities. The transceiver 114 includes other components that enable wireless communication (for example, amplifiers, antennas, baseband processors, and the like), which for brevity are not described herein and which may be implemented in hardware, software, or a combination of both. Some instances include multiple transceivers or separate transmitting and receiving components (for example, a transmitter and a receiver) instead of a combined transceiver.

The HMI 116 provides visual output, such as, for example, graphical indicators (i.e., fixed or animated icons), lights, colors, text, images, combinations of the foregoing, and the like. The HMI 116 includes a suitable display mechanism for displaying the visual output, such as, for example, an instrument cluster, a mirror, a heads-up display, a center console display screen (for example, a liquid crystal display (LCD) touch screen, or an organic light-emitting diode (OLED) touch screen), or other suitable mechanisms. In alterative embodiments, the display screen may not be a touch screen. In some instances, the HMI 116 displays a graphical user interface (GUI) (for example, generated by the electronic controller and presented on a display screen) that enables a driver or passenger to interact with the autonomous vehicle 102. The HMI 116 may also provide audio output to the driver such as a chime, buzzer, voice output, or other suitable sound through a speaker included in the HMI 116 or separate from the HMI 116. In some instances, HMI 116 provides haptic outputs to the driver by vibrating one or more vehicle components (for example, the vehicle's steering wheel and the seats), for example, using a vibration motor. In some instances, HMI 116 provides a combination of visual, audio, and haptic outputs.

In some instances, the electronic controller 104, using the transceiver 114, communicates with a mobile electronic device 126. In alternative embodiments, the mobile electronic device 126, when near to or inside the autonomous vehicle 102, may be communicatively coupled to the electronic controller 104 via a wired connection using, for example, a universal serial bus (USB) connection or similar connection. The mobile electronic device 126 may be, for example, a smart telephone, a tablet computer, personal digital assistant (PDA), a smart watch, or any other portable or wearable electronic device that includes or can be connected to a network modem or similar components that enable wireless or wired communications (for example, a processor, memory, i/o interface, transceiver, antenna, and the like). In some instances, the HMI 116 communicates with the mobile electronic device 126 to provide the visual, audio, and haptic outputs through the mobile electronic device 126 when the mobile electronic device 126 is communicatively coupled to the autonomous vehicle 102.

FIG. 2 illustrates an example embodiment of the electronic controller 104, which includes an electronic processor 205 (for example, a microprocessor, application specific integrated circuit, etc.), a memory 210, and an input/output interface 215. The memory 210 may be made up of one or more non-transitory computer-readable media and includes at least a program storage area and a data storage area. The program storage area and the data storage area can include combinations of different types of memory, such as read-only memory (“ROM”), random access memory (“RAM”) (for example, dynamic RAM (“DRAM”), synchronous DRAM (“SDRAM”), etc.), electrically erasable programmable read-only memory (“EEPROM”), flash memory, or other suitable memory devices. The electronic processor 205 is coupled to the memory 210 and the input/output interface 215. The electronic processor 205 sends and receives information (for example, from the memory 210 and/or the input/output interface 215) and processes the information by executing one or more software instructions or modules, capable of being stored in the memory 210, or another non-transitory computer readable medium. The software can include firmware, one or more applications, program data, filters, rules, one or more program modules, and other executable instructions. The electronic processor 205 is configured to retrieve from the memory 210 and execute, among other things, software for autonomous and semi-autonomous vehicle control, and for performing methods as described herein. In the embodiment illustrated, the memory 210 stores, among other things, a vibration detection algorithm 220, which operates as described herein to detect vibration and classify vibration patterns to identify component anomalies.

The input/output interface 215 transmits and receives information from devices external to the electronic controller 104 (for example, over one or more wired and/or wireless connections), for example, components of the system 100 via the bus 118. The input/output interface 215 receives input (for example, from the sensors 108, the HMI 116, etc.), provides system output (for example, to the HMI 116, etc.), or a combination of both. The input/output interface 215 may also include other input and output mechanisms, which for brevity are not described herein and which may be implemented in hardware, software, or a combination of both.

In some instances, the electronic controller 104 uses one or more machine learning methods to analyze vibration data to identify component anomalies (as described herein). Machine learning generally refers to the ability of a computer program to learn without being explicitly programmed. In some instances, a computer program (for example, a learning engine) is configured to construct an algorithm based on inputs. Supervised learning involves presenting a computer program with example inputs and their desired outputs. The computer program is configured to learn a general rule that maps the inputs to the outputs from the training data it receives. Example machine learning engines include decision tree learning, association rule learning, artificial neural networks, classifiers, inductive logic programming, support vector machines, clustering, Bayesian networks, reinforcement learning, representation learning, similarity and metric learning, sparse dictionary learning, and genetic algorithms. Using these approaches, a computer program can ingest, parse, and understand data and progressively refine algorithms for data analytics.

It should be understood that although FIG. 2 illustrates only a single electronic processor 205, memory 210, and input/output interface 215, alternative embodiments of the electronic controller 104 may include multiple processors, memory modules, and/or input/output interfaces. It should also be noted that the system 100 may include other electronic controllers, each including similar components as, and configured similarly to, the electronic controller 104. In some instances, the electronic controller 104 is implemented partially or entirely on a semiconductor (for example, a field-programmable gate array [“FPGA”] semiconductor) chip. Similarly, the various modules and controllers described herein may be implemented as individual controllers, as illustrated, or as components of a single controller. In some instances, a combination of approaches may be used.

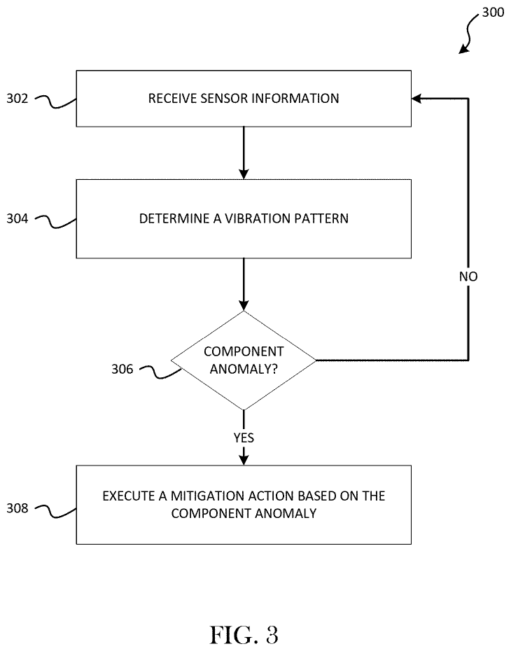

FIG. 3 illustrates an example method 300 for automatically detecting, classifying, and/or mitigating vehicle component anomalies. Although the method 300 is described in conjunction with the system 100 as described herein, the method 300 could be used with other systems and vehicles. In addition, the method 300 may be modified or performed differently than the specific example provided. As an example, the method 300 is described as being performed by the electronic controller 104 and, in particular, the electronic processor 205. However, it should be understood that in some instances, portions of the method 300 may be performed by other devices or subsystems of the system 100.

At block 302, the electronic processor 205 receives sensor information from a first sensor (for example, the vibration sensor 110) positioned at a first position on the vehicle and configured to sense vibrations of the vehicle. For example, the electronic processor 205 may receive signals (for example, via a CAN bus) from an accelerometer positioned on a wheel of the vehicle. In some instances, the electronic processor 205 receives the sensor information continuously. In some instances, the electronic processor 205 receives periodic bursts of sensor information from the vibration sensor 110. In some instances, the sensor information is stored in a buffer or other memory of the electronic controller 104 until it can be processed.

At block 304, the electronic processor 205 determines a vibration pattern based on the sensor information. In some instances, the vibration pattern is determined by taking a sample of the sensor information. In some instances, the electronic processor 205 compares the sensor information to a vibration noise floor to extract one or more vibrations that exceed the vibration noise floor. In some instances, the vibration noise floor is a pre-determined value set by the vehicle manufacture. In some instances, the vibration noise floor may be established by the electronic processor 205 as the vehicle operates over time. For example, the electronic processor 205 may periodically sample vibration information during ordinary vehicle operations and average the samples to establish a vibration noise floor. In some instances, the vibration noise floor value is adjusted based on current vehicle operating conditions. For example, the vehicle's current speed and acceleration may be used to adjust the noise floor up or down to compensate for vibrations added by the operation of the vehicle. In some instances, the vibration noise floor is determined continuously using sensor information from other vibration sensors. For example, for a vehicle having one vibration sensor on each wheel, the electronic processor 205 may average the readings of all four sensors to determine the vibration noise floor. In another example, the electronic processor 205 may average the readings of the sensors that are not being used to produce the vibration pattern to determine the vibration noise floor.

Regardless of how the vibration noise floor is determined, the electronic processor 205 may generate the vibration pattern based on the one or more vibrations that exceed the vibration noise floor.

At block 306, the electronic processor 205 determines, based on the vibration pattern, whether a component anomaly has occurred. For example, the electronic processor 205 may use a pattern matching algorithm to determine whether the vibration event matches a known vibration pattern associated with a particular component anomaly. In some instances, the electronic processor 205 may determine whether a component anomaly exists based on the vibration pattern and one or more vehicle attributes (for example, received from one or more of the vehicle control systems 106 or the sensors 108). For example, some types of vibrations may be more indicative of a particular component failure when they occur during a braking (for example, warped rotors) or steering (for example, worn tie rods) maneuver. For example, the electronic processor 205 may determine one or more vehicle attributes for a time period beginning just before the vibration pattern starts and ending just after the vibration pattern ends (for example, five seconds before and after the vibration pattern occurred).

In some instances, the electronic processor 205 determines that a component anomaly exists by classifying the vibration pattern using a machine learning algorithm (for example, a neural network or a classifier), executable by the electronic processor 205. In some instances, the machine learning algorithm is trained using historical component anomaly data. For example, the machine learning algorithm is fed training data that includes example inputs (for example, vibration pattern data representative of particular component anomalies) and corresponding desired outputs (for example, indications of the component anomaly). The training data may also include metadata for the vibration patterns. Metadata may include, for example, the vehicle speed at the time of the vibration pattern, the model of vehicle in which the vibration pattern was sensed, the state of the vehicle at the time of the vibration pattern (for example, braking, accelerating, turning, etc.), and environmental conditions at the time of the vibration pattern (for example, ambient temperature, ambient humidity, weather conditions, road conditions, etc.). By processing the training data, the machine learning algorithm progressively develops a prediction model that maps inputs to the outputs included in the training data.

In some instances, the vibration pattern is fed into the machine learning algorithm, which identifies the cause of the component anomaly. In some instances, the machine learning algorithm generates multiple potential component anomalies based on the vibration data, and determines, for each potential component anomaly, a confidence score. A confidence score indicates how likely it is that the potential component anomaly is the cause of the vibration pattern (for example, how closely the sensed vibration pattern matches to vibration patterns for the same type of potential component anomaly). In such embodiments, the electronic processor 205 selects the component anomaly from the plurality of potential component anomalies based on the confidence score. For example, the potential component anomaly with the highest confidence score may be selected. In some instances a confidence score is a numerical representation (for example, from 0 to 1) confidence. For example, the vibration pattern may be a 60% match with one potential component anomaly but may be an 80% match with another potential component anomaly, resulting in confidence scores of 0.6 and 0.8, respectively.

Optionally, in some instances, the electronic processor 205 assigns a weight to one or more of the potential component anomalies based on metadata for the vibration pattern and the potential component anomaly and selects the component anomaly from the plurality of potential component anomalies based on the confidence score and the weight.

The weight is used to indicate a how significant a particular piece of metadata is to identify a potential component anomaly as the component anomaly, relative to the other potential component anomalies. For example, where both the vehicle experiencing the component anomaly and the vehicle that produced the training data for potential component anomaly are the same model, the potential component anomaly may be assigned a higher weight than would be assigned for the case where the metadata indicates two different vehicle models. In another example, where the vehicle experiencing the component anomaly was accelerating and the vehicle that produced the training data for potential component anomaly was decelerating, the potential component anomaly may be assigned a lower weight that where the metadata indicates that both vehicles were accelerating. Metadata with higher weights contribute more to the confidence score. For example, a smaller quantity of higher weighted metadata may result in a higher confidence score than a larger quantity of lower-weighted metadata. In such embodiments, the electronic processor 205 determines, for each of the plurality of potential component anomalies, a weighted confidence score based on the confidence score and the weight. For example, the electronic processor 205 may multiply the confidence scores by the weight assigned. In such embodiments, the electronic processor 205 selects the component anomaly from the plurality of potential component anomalies based on the weighted confidence score. For example, the component anomaly with the highest weighted confidence score may be selected.

In some instances, weights are statically pre-determined for each type of metadata. In some instances, the weights may be determined using the machine learning algorithm. Over time, as matches are determined for vibration patterns and confirmed or rejected by observation, the machine learning algorithm may determine that particular metadata are more determinative to a high confidence score than others, and thus increase the weight for those metadata.

As illustrated in FIG. 3, when the electronic processor 205 does not determine (at block 306) that a component anomaly has occurred (for example, the vibration pattern does not match a known component anomaly), the electronic processor 205 continues receiving (at block 302) and processing sensor data to detect component anomalies. In some instances, the electronic processor 205 is configured to continuously to detect and classify component anomalies. In other embodiments, the electronic processor 205 is configured to execute the method 300 periodically to detect component anomalies.

Regardless of how the component anomaly is determined, at block 308, the electronic processor 205 executes a mitigation action based on the component anomaly. In some instances, the mitigation action includes transmitting (for example, via the transceiver 114) a notification to a fleet operator. For example, a suitable network message or API may be used to send a notification that indicates a component anomaly has occurred, the time and place of the component anomaly, the type of the component anomaly, and the like. The fleet operator, in response to receiving the notification, may issue commands to the electronic controller 104 to drive the vehicle to a fleet facility for maintenance, to drive the vehicle safely out of traffic (if required) until another vehicle can be sent for the passenger(s), etc.

In some instances, the mitigation action includes transmitting (for example, via the transceiver 114) a notification to a public safety agency. For example, in the event that a potentially dangerous problem is causing the vibration pattern, the electronic processor 205 may send an alert relaying the information about a vehicle in distress and other information using an E911 system.

In some instances, the mitigation action includes controlling the vehicle to exit traffic. For example, where the component anomaly is more serious, the electronic controller 104 may autonomously operate the vehicle to travel pull off the roadway into a parking lot or other location relatively free of vehicle traffic. In some instances, the electronic controller 104 may autonomously operate the vehicle to travel to travel to a maintenance facility.

In some instances, the mitigation action includes producing an alert on a human machine interface of the vehicle to inform any passengers of the component anomaly and any other mitigation actions being taken. For example, a display of the HMI 116 may display a message such as “VEHICLE BRAKES REQUIRE MAINTENANCE. WE ARE PROCEEDING TO A SERVICE FACILITY TO ASSESS FURTHER.” or “VEHICLE WHEELS ARE OUT OF ALIGNMENT. THE VEHICLE OPERATOR IS BEING ALERTED AND MAXIMUM VEHICLE SPEED WILL BE REDUCED UNTIL THE PROBLEM IS ADDRESSED.” In some instances, the HMI 116 may speak the alerts aloud to the vehicle passenger. In some instances, a combination of alerts may be used. In some instances, the electronic processor 205 may send an alert to a mobile electronic device of the passenger (for example, using the transceiver 114).

In some instances, multiple mitigation actions are combined.

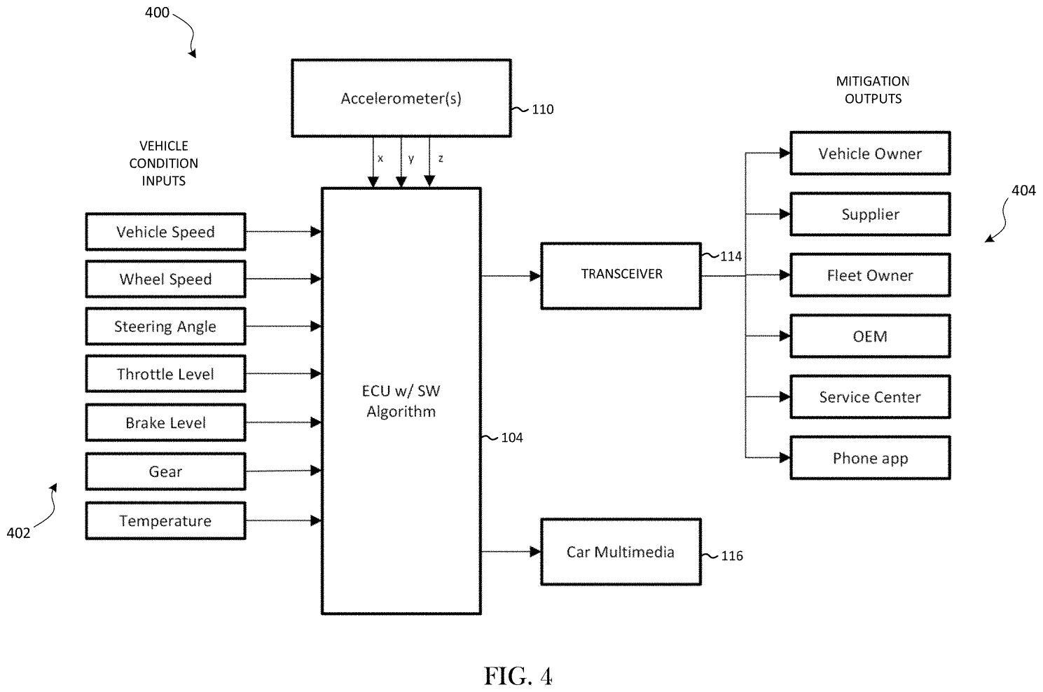

FIG. 4 is a block diagram of one example of an autonomous vehicle control system 400. In the system 400, the electronic controller 104 receives sensor information from one or more accelerometers 110 and one or more vehicle condition inputs 402. As described herein, the electronic controller 104 uses the sensor information and vehicle condition inputs to detect component anomalies and report the anomalies to various mitigation outputs 404 (using the transceiver 114), the HMI 116, or both.

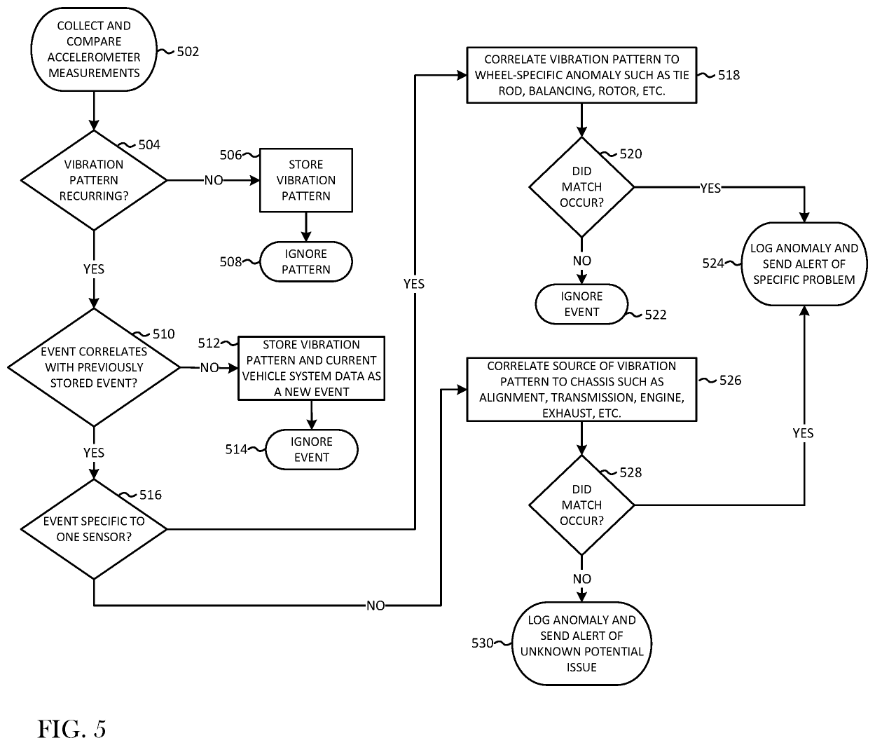

FIG. 5 illustrates an example method 500 for automatically detecting, classifying, and/or mitigating vehicle component anomalies. Although the method 500 is described in conjunction with the systems 100 and 400 as described herein, the method 500 could be used with other systems and vehicles. In addition, the method 500 may be modified or performed differently than the specific example provided. As an example, the method 500 is described as being performed by the electronic controller 104 and, in particular, the electronic processor 205. However, it should be understood that in some instances, portions of the method 500 may be performed by other devices or subsystems of the systems 100 and 400.

At block 502, the electronic processor 205 collects and compares accelerometer measurements to determine a vibration pattern, as described herein.

At block 504, the electronic processor 205 determines whether the vibration pattern is a reoccurring pattern (that is, has it occurred more than once). For example, the electronic processor 205 may compare the current vibration pattern to a library of detected vibration patterns stored in a memory of the electronic controller 104. In some instances, a vibration pattern may have to exceed a threshold reoccurrence value before the electronic processor 205 determines that it is a reoccurring vibration pattern. For example, in some instances, the vibration pattern may have to occur three or more times to be considered reoccurring. At block 506, when the vibration pattern is not reoccurring, the electronic processor 205 stores the vibration pattern (for example, in the memory 210) for comparison to future-detected vibration patterns and ignores the vibration pattern (at block 508). In some instances, when a vibration pattern is ignored, the electronic processor 205 continues to analyze sensor information for vibration patterns (at block 502).

At block 510, responsive to determining that the vibration pattern is a reoccurring vibration pattern, the electronic processor 205 determines whether the vibration event correlates with a previously stored vibration event. The term “vibration event,” as used herein, represents a detected reoccurring vibration pattern combined with metadata associated with the vibration pattern. In some instances, the metadata includes current vehicle system data for a timeframe including the time during which the reoccurring vibration pattern is sensed. Vehicle system data may include values for the vehicle condition inputs 402, condition values or commands from the vehicle systems 106, inputs from the sensors 108, or combinations of the foregoing. In some instances, the electronic processor 205 determines whether the vibration event correlates with a previously stored vibration event by utilizing similar techniques as described herein with regard to the method 300 and determining whether a component anomaly exists.

In some instances, the electronic processor combines the functions of blocks 504 and 510 to check for reoccurring vibration events, rather than first checking for reoccurring vibration patterns. For example, each time a vibration pattern is detected, the metadata is combined to create a vibration event, which is then checked for reoccurrence before proceeding to block 516.

At block 512, when the vibration event does not correlate with a previously stored vibration event, the electronic processor 205 stores the vibration event as a new event (for example, in the memory 210) and ignores the vibration event (at block 514). In some instances, when a vibration event is ignored, the electronic processor 205 continues to analyze sensor information for vibration patterns and possible vibration events (at block 502).

At block 516, when the vibration event does correlate with a previously stored vibration event, the electronic processor 205 determines whether the vibration event is specific to one sensor (i.e., the vibration pattern was detected at only one of many vibration sensors). For example, the electronic processor 205 compares data from multiple accelerometers 110 to determine whether the vibration pattern comprising the vibration event is detected at only one or more than one of the accelerometers 110. At block 518, when the vibration event is specific to one sensor, the electronic processor 205 correlates the vibration pattern to a wheel-specific anomaly (for example, related to the wheel at which the one sensor is positioned). At block 520, the electronic processor 205 determines whether the vibration pattern matches a particular type of component anomaly (as described herein). At block 522, if it does not match, then the vibration event is ignored. In some instances, when a vibration event is ignored, the electronic processor 205 continues to analyze sensor information for vibration patterns and possible vibration events (at block 502). At block 524, if it does match, then the anomaly is logged, and a mitigation action is taken (for example, by sending an alert).

At block 526, when the event is not specific to one sensor (i.e., the vibration pattern is sensed at more than one of many vibration sensors), the electronic processor 205 correlates the source of the vibration pattern to the vehicle chassis (for example, alignment, transmission, engine, exhaust, and the like). At block 528, the electronic processor 205 determines whether the vibration pattern matches a particular type of component anomaly (as described herein). At block 530, if it does not match, the event is logged, and an alert is sent regarding an unknown or unspecified potential issue with the vehicle. At block 524, if it does match, then the anomaly is logged, and a mitigation action is taken (for example, by sending an alert).

Thus, the embodiments described herein provide, among other things, a control system for an autonomous vehicle configured to detect and mitigate component anomalies.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

In addition, the phraseology and terminology used herein is for the purpose of description and should not be regarded as limiting. In this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. A device or structure that is “configured” in a certain way is configured in at least that way but may also be configured in ways that are not listed.

Various features, advantages, and embodiments are set forth in the following claims.

What is claimed is:

1. A system for detecting component anomalies for a vehicle, the system comprising:
a first sensor positioned at a first position on the vehicle and configured to sense vibrations of the vehicle; and
an electronic processor communicatively coupled to the first sensor and configured to receive, from the first sensor, sensor information produced by a sensed
vibration of the vehicle;
determine, based on the sensor information, a vibration pattern;
determine, based on the vibration pattern, whether a component anomaly exists; and
in response to determining that a component anomaly exists, execute a mitigation action based on the component anomaly.

2. The system of claim 1, wherein the electronic processor is configured to determine the vibration pattern by:
comparing the sensor information to a vibration noise floor to extract one or more vibrations that exceed the vibration noise floor; and
generating the vibration pattern based on the one or more vibrations that exceed the vibration noise floor.

3. The system of claim 1, wherein the electronic processor is further configured to:
determine a vehicle attribute; and
determine whether a component anomaly exists based on the vibration pattern and the vehicle attribute.

4. The system of claim 1, wherein the electronic processor is configured to determine whether a component anomaly exists by classifying the vibration pattern using a machine learning algorithm.

5. The system of claim 4, wherein the machine learning algorithm is trained on historical component anomaly data.

6. The system of claim 5, wherein the electronic processor is further configured to classify the vibration pattern using a machine learning algorithm by
generating a plurality of potential component anomalies based on the vibration pattern;
determining, for each of the potential component anomalies, a confidence score; and
selecting the component anomaly from the plurality of potential component anomaly based on the confidence scores.

7. The system of claim 6, wherein the electronic processor is further configured to:
assign a weight to each of the plurality of potential component anomalies based on metadata for the potential component anomaly; and
select the component anomaly from the plurality of potential component anomalies based on the confidence score and the weight.

8. The system of claim 1, further comprising:
a second sensor positioned at a second position on the vehicle and configured to sense vibrations of the vehicle, wherein the electronic processor is communicatively coupled to the second sensor and further configured to
receive, from the second sensor, additional sensor information produced by the sensed vibration of the vehicle; and
determine the vibration pattern based on the sensor information and the additional sensor information.

9. The system of claim 1, wherein the electronic processor is further configured to:
prior to determining whether a component anomaly exists, determine whether the vibration pattern is reoccurring; and
determine whether a component anomaly exists in response to determining that the vibration pattern is reoccurring.

10. The system of claim 1, wherein the mitigation action is at least one selected from the group consisting of transmitting a notification to a vehicle owner, transmitting a notification to a fleet operator, transmitting a notification to a vehicle manufacturer, transmitting a notification to a public safety agency, controlling the vehicle to exit traffic, and producing an alert on a human machine interface of the vehicle.

11. The system of claim 1, wherein the first sensor is an accelerometer.

12. The system of claim 3, wherein the vehicle attribute is at least one selected from the group consisting of a vehicle speed, a wheel speed, a steering angle, a throttle level, a braking level, a gear selection, and a temperature.

13. A method for detecting component anomalies for a vehicle, the method comprising:
receiving, from a first sensor positioned at a first position on the vehicle, sensor information produced by a sensed vibration of the vehicle;
comparing, with an electronic processor communicatively coupled to the first sensor, the sensor information to a vibration noise floor to extract one or more vibrations that exceed the vibration noise floor;
generating a vibration pattern based on the one or more vibrations that exceed the vibration noise floor;
determining, based on the vibration pattern, whether a component anomaly exists; and
in response to determining that a component anomaly exists, executing a mitigation action based on the component anomaly.

14. The method of claim 13, further comprising:
determining a vehicle attribute; and
determining whether a component anomaly exists based on the vibration pattern and the vehicle attribute.

15. The method of claim 13, wherein determining whether a component anomaly exists includes classifying the vibration pattern using a machine learning algorithm.

16. The method of claim 15, wherein the machine learning algorithm is trained on historical component anomaly data.

17. The system of claim 16, wherein classifying the vibration pattern using a machine learning algorithm further includes:
generating a plurality of potential component anomalies based on the vibration pattern;
determining, for each of the potential component anomalies, a confidence score; and
selecting the component anomaly from the plurality of potential component anomaly based on the confidence scores.

18. The method of claim 17, further comprising:
assigning a weight to each of the plurality of potential component anomalies based on metadata for the potential component anomaly; and
selecting the component anomaly from the plurality of potential component anomalies based on the confidence score and the weight.

19. The method of claim 13, further comprising:
receiving, from a second sensor positioned at a second position on the vehicle, additional sensor information produced by the sensed vibration of the vehicle; and
determining the vibration pattern based on the sensor information and the additional sensor information.

20. The method of claim 13, further comprising:
prior to determining whether a component anomaly exists, determining whether the vibration pattern is reoccurring; and
determining whether a component anomaly exists in response to determining that the vibration pattern is reoccurring.

21. The method of claim 13, wherein executing the mitigation action includes performing at least at least one selected from the group consisting of transmitting a notification to a vehicle owner, transmitting a notification to a fleet operator, transmitting a notification to a vehicle manufacturer, transmitting a notification to a public safety agency, controlling the vehicle to exit traffic, and producing an alert on a human machine interface of the vehicle.

22. The method of claim 13, wherein receiving sensor information from the first sensor includes receiving sensor information from an accelerometer.

23. The method of claim 14, wherein determining the vehicle attribute includes determining at least one selected from the group consisting of a vehicle speed, a wheel speed, a steering angle, a throttle level, a braking level, a gear selection, and a temperature.
